(19) United States
(12) Patent Application Publication
(10) Pub. No.: US 2022/0050875 A1
(43) Pub. Date: Feb. 17, 2022

(54) Time Period Data Comparison

(71) Applicant: Business Objects Software LTD, Dublin (IE)

(72) Inventors: Lauren Low, Surrey (CA); Brett Wakefield, Delta (CA); Christina Obry, Vancouver (CA); Sheng Li, Coquitlam (CA); Lauren Fung, Vancouver (CA); Philip Mark, Vancouver (CA); Erik Schmidt, Vancouver (CA); Qiushan Zhao, Vancouver (CA); Ali Moosavi, Vancouver (CA); Jia Zheng Liao, Richmond (CA)

(21) Appl. No.: 17/089,453

(22) Filed: Nov. 4, 2020

Related U.S. Application Data
(60) Provisional application No. 63/066,764, filed on Aug. 17, 2020.

(51) Int. Cl. G06F 16/906; G06F 16/904; G06F 16/9035; G06F 11/30; G06F 11/32

(52) U.S. Cl. CPC G06F 16/906; G06F 16/904; G06F 11/323; G06F 11/3075; G06F 16/9035

(57) ABSTRACT

The present disclosure relates to comparisons of data over time and generating recommendations to create such comparisons. A visualization in an analytics application may include a plurality of data points and a user may select of one or more of the data points to configure the visualization. If the context of the visualization is based on time, the software may determine whether the one or more selected data points includes the current time period. If so, comparisons of the data over time may be included in the visualization and creation of these comparisons may be recommended to the user. One or more data comparisons may be determined by comparing each of the one or more selected data points to a corresponding data point in a previous time period. An updated visualization including the selected data points and the data comparisons may be provided.

### CROSS REFERENCE TO RELATED APPLICATIONS

This application claims the benefit of U.S. Provisional Patent Application No. 63/066,764, titled “TIME PERIOD DATA COMPARISON” and filed on Aug. 17, 2020, the content of which is hereby incorporated herein by reference in its entirety for all purposes.

### BACKGROUND

The present disclosure relates to computing and data processing and in particular to comparisons of data over time.

Data analytics software applications enable users to view and analyze large sets of data. A user may use analytics software to view data points and aggregations based on specific criteria, such as category, type, or time period. Such information may be used to plan for future activities. In order to make decisions, it may be important for the planning user to understand how one set of data compares to another set of data over one or more time periods. For instance, a report of sales per month may not be sufficient on its own to inform a user of whether that month's sales was good or not. In order to determine whether the sales were good or not, the user would need to know whether the sales were higher or lower compared to sales in a previous time period. For example, the sales for one month may be compared to the previous month, or to the same month in the previous year, in order to determine the performance for that month. Such comparisons may be crucial to user's understanding of the data and they may enable the user to draw useful conclusions to guide their planning and decision making.

It would be advantageous for data analytics software to provide comparisons of data over time. The present disclosure addresses these issue and others, as further described below.

### SUMMARY

The present disclosure provides a computer system. The computer system includes one or more processors and one or more machine-readable medium coupled to the one or more processors. The one or more machine-readable medium store computer program code comprising sets instructions. The instructions are executable by the one or more processors to generate a visualization including a plurality of data points based on data retrieved by querying a server. The visualization being for display on a user interface. The instructions are further executable by the one or more processors to determine a selection of one or more selected data points of the plurality of data points. The selection being made using the user interface. The instructions are further executable by the one or more processors to determine that a context of the visualization is based on time. The instructions are further executable by the one or more processors to determine one or more data comparisons by comparing each of the one or more selected data points to a corresponding data point in a previous time period. The instructions are further executable by the one or more processors to generate a second visualization including the one or more selected data points and the one or more data comparisons for presentation in the user interface.

The present disclosure provides one or more non-transitory computer-readable medium storing computer program code. The computer program code including sets of instructions to generate a visualization including a plurality of data points based on data retrieved by querying a server. The visualization being for display on a user interface. The computer program code further including sets of instructions to determine a selection of one or more selected data points of the plurality of data points. The selection made using the user interface. The computer program code further including sets of instructions to determine that a context of the visualization is based on time. The computer program code further including sets of instructions to determine one or more data comparisons by comparing each of the one or more selected data points to a corresponding data point in a previous time period. The computer program code further including sets of instructions to generate a second visualization including the one or more selected data points and the one or more data comparisons for presentation in the user interface.

The present disclosure further provides a computer-implemented method. The method includes generating a visualization including a plurality of data points. The visualization may be based on data retrieved by querying a server. The visualization may be used for display on a user interface. The method further includes determining a selection of one or more selected data points of the plurality of data points. The selection may be made using the user interface. The method further includes determining that a context of the visualization is based on time. The method further includes determining one or more data comparisons by comparing each of the one or more selected data points to a corresponding data point in a previous time period. The method further includes generating a second visualization including the one or more selected data points and the one or more data comparisons for presentation in the user interface.

The following detailed description and accompanying drawings provide a better understanding of the nature and advantages of the present disclosure.

### BRIEF DESCRIPTION OF THE DRAWINGS

FIG. 1 shows a diagram of a computer system including a front-end computer and a back-end computer, according to an embodiment.

FIG. 2 shows a flowchart of a computer implemented method, according to an embodiment.

FIG. 3 shows a diagram of an exemplary visualization of data presented in a user interface, according to an embodiment.

FIG. 4 shows a diagram of an exemplary visualization of data and a selection of data points, according to an embodiment.

FIG. 5 shows a diagram of an exemplary visualization of data and a selection of data points including a current time period, according to an embodiment.

FIG. 6 shows a diagram of an exemplary visualization of data with time-based comparisons dynamically adjusting based on a time period level, according to an embodiment.

FIG. 7 shows a diagram of an exemplary visualization of data with time-based comparisons and an interface control option to select a custom current date, according to an embodiment.

FIG. 8 shows a diagram of recommendations for comparisons to generate for a visualization of data, according to an embodiment.

FIG. 9 shows a diagram of a notification regarding comparisons of data, according to an embodiment.

FIG. 10 shows a diagram of hardware of a special purpose computing machine for implementing systems and methods described herein.

### DETAILED DESCRIPTION

In the following description, for purposes of explanation, numerous examples and specific details are set forth in order to provide a thorough understanding of the present disclosure. Such examples and details are not to be construed as unduly limiting the elements of the claims or the claimed subject matter as a whole. It will be evident to one skilled in the art, based on the language of the different claims, that the claimed subject matter may include some or all of the features in these examples, alone or in combination, and may further include modifications and equivalents of the features and techniques described herein.

As mentioned above, it may be important for the planning user to understand how one set of data compares to another set of data over different time periods in order to plan and make decisions. For example, a report of sales per month may not be sufficient on its own to inform a business user of whether that month's sales was good or not. In order to determine whether the sales were good or not, the user would need to know whether the sales were higher or lower compared to a previous time period. To get this information, the sales for that month may be compared to the previous month or to the same month in the previous year, for example. Such comparisons may be crucial to user's understanding of the data and they may enable the user to draw useful conclusions to guide their planning and decision making. Such comparisons of data over time may be referred to as a “variance.” In some embodiments, these comparisons of data over time may be added on top of an existing visualization (e.g., a chart or graph) of data.

Providing the comparisons of data over time can be advantageous because it may enable users to determine trends and make decisions based on those trends. Accordingly, it would be advantageous for data analytics software to provide comparisons of data over time. However, it may be difficult for a designer of the software application to predict which types of comparisons may be useful to the user given that each user's data will be different. Furthermore, generating such comparisons of data may require detailed knowledge of the underlying data (e.g., the reports) and detailed knowledge of the data analytics software (e.g., menus and configuration settings), thereby limiting the number of people capable of creating comparisons of the data.

The present disclosure describes techniques for automatically recommending creation of comparisons of data over time in the user interface of an analytics application. By following the recommendations, comparisons of data over time may be configured by users without detailed knowledge of the underlying data and detailed knowledge of the data analytics software. The recommendations and the comparisons of data over time are described in further detail below.

The comparisons of data over time may be presented within a visualization of data (e.g., chart, graph, table, etc.) in a user interface of an analytics application, for example. The visualization may be presented within a collection of data visualizations (e.g., a dashboard, page, or story). Features of the present disclosure include automatically generating recommendations for creating comparisons over time based on the data used in a visualization. These recommendations may be presented to users as they view visualizations of data in the analytics application, within the visualization, along side the visualization, or within a menu corresponding to the visualization. Including recommendations to create comparisons of data over time along with the visualization is advantageous because it improves discoverability of the data comparisons feature, helping to ensure that such comparisons are included which may improve planning and decision making as described herein.

Another feature of the present disclosure is enabling creation of comparison of data for view-time users (e.g., non-designers or non-admin users) in addition to design-time users. In some prior solutions, view-time users may not have permission to modify the visualization to include comparisons of data, or the view-time users may have lacked the expertise to create such comparisons. The techniques described herein provide recommendations to view-time users in addition to the design-time users such that both may create and include comparisons of data in their visualizations. Furthermore, different view-time users may create and save (e.g., bookmark) different comparisons of data over time for the same visualization.

Given the importance of reviewing comparisons of data over time, the present disclosure automatically generates recommendations to create such variances or comparisons of data over time in situations where it would be possible to incorporate the comparisons into the visualization (e.g., a chart or graph in a user interface of an analytics application). For example, the recommendations may be displayed in a visualization configuration menu or panel used by a designer of the visualization, and also in a context-menu used by viewers of the visualization. By utilizing the recommendations, users may be able to apply a time filter to the visualization and create comparisons of data over time in just a few clicks in the user interface, as further described below.

In order to determine whether comparisons over time may be provided, the analytics application may determine whether time (e.g., a time period) is in a context of a particular visualization. For example, the visualization may be filtered based on a particular time period (e.g., a chart showing sales by region over the past year) or the visualization may include time along an axis (e.g., sales per month, per quarter, or per year). If time is in the visualization's context such that comparisons over time may be determined, then recommendations to create data comparisons based on time may be generated and presented in the user interface. The user may select the recommendation and in response, the software may calculate the comparisons and present them in the user interface (e.g., along side or on top of the data for the existing visualization). Furthermore, the user may select particular time periods (e.g., by selecting one or more bars of a bar graph, lines in a chart, or data points, etc.) and recommendations for comparisons may be generated based on those time periods and presented in the user interface. If the user selects the current time period (e.g., the current years, the current quarter, or the current month), the software may enable the user to add a dynamic comparison to the visualization that tracks the current time period. That is, the dynamic comparison may be automatically adjusted based on the current month as time goes on.

In addition, the user may want to view the data and dynamic comparisons in the visualization as they were in the past. The analytics application may provide a control selection in the user interface allowing the user to select a custom current time period that is different from the actual current time period. For example, if it is currently the fourth quarter, the user may use the control selection to set the second quarter as the current time period. The visualization may be updated to show data as if the current date were actually in the second quarter. Thus, the user can review data in the visualization as it would have displayed in the past, thereby enabling them to review the comparisons over time from that perspective.

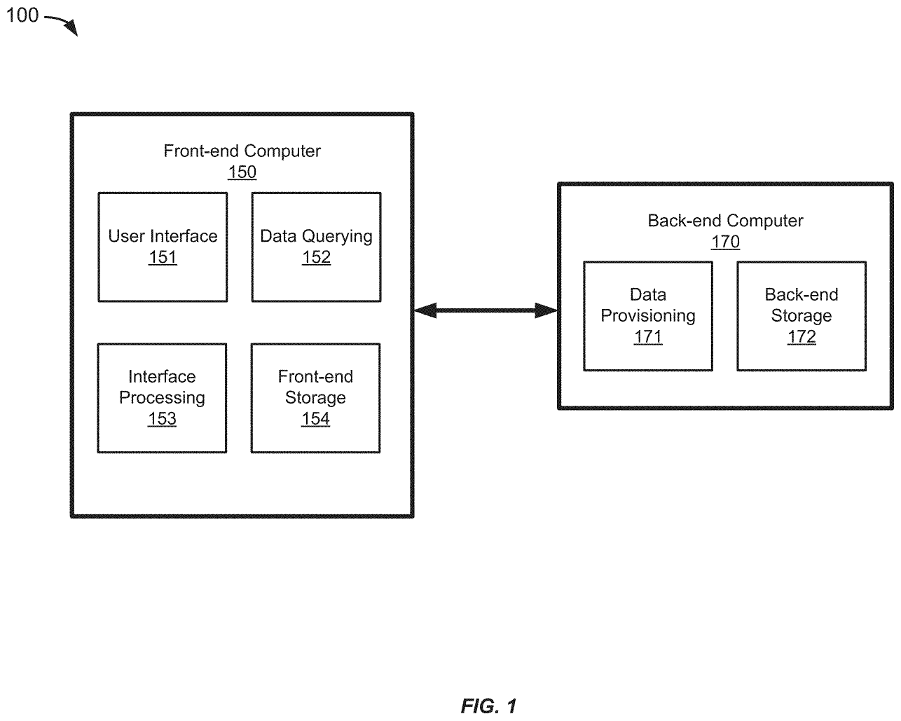

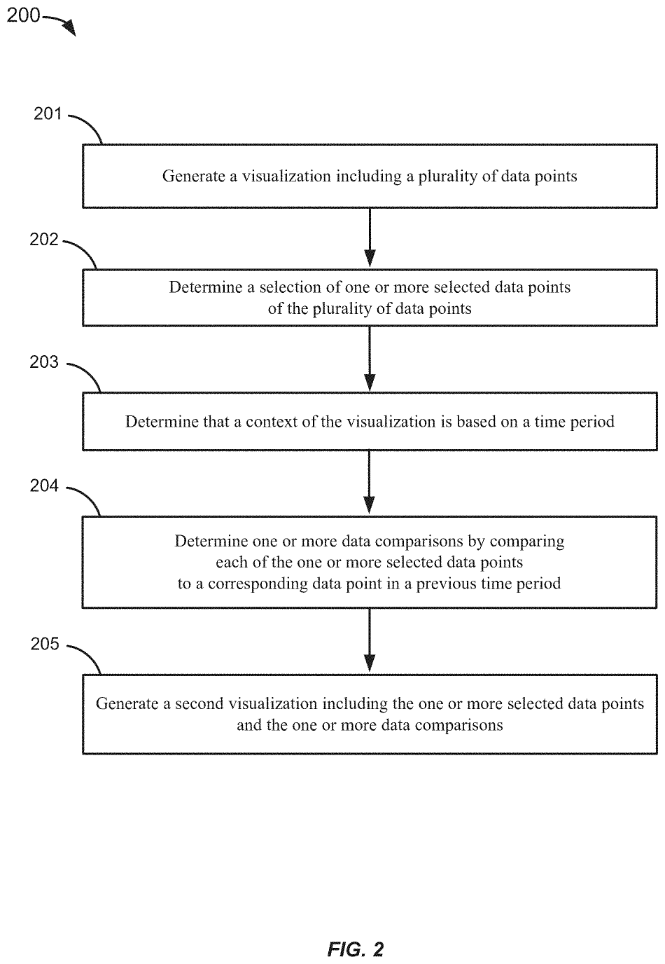

An exemplary computer system providing the analytics application is described below with respect to FIG. 1 and examples of visualizations and the recommendations for creating data comparisons are described below with respect to FIGS. 2-8.

The improved techniques for recommending and generating time period data comparisons may be implemented in a front-end of a cloud-based application, for example. The cloud application may be implemented by a web browser of the front-end computer. The cloud application may query and receive data from a remote back-end computer over a network. The queried data may be used for visualizing the data (e.g., in charts and graphs). The data at the back-end computer may be referred to as being “in the cloud.” While cloud applications are described herein, the techniques for time based data comparisons may be implemented in any other software applications or platforms.

FIG. 1 shows a diagram 100 of a computer system including a front-end computer 150 and a back-end computer 170, according to an embodiment. The front-end computer 150 may be referred to as a “front-end computer” because it may provide a user interface visualizing data received from a database running on the “back-end computer.” In many situations, the user may see and be aware of the front-end but not the back-end. The front-end computer 150 may be a desktop computer, laptop computer, user device, server computer, or a system of more than one computer, for example. The front-end computer 150 implements the improved user interface providing recommendations for comparisons of data and the comparisons of data described herein.

The front-end computer 150 may include a user interface software module 151, an interface data querying software module 152, an interface processing software module 153, and a front-end storage software module 154. In some embodiments, the user interface 151, data querying 152, and interface processing 153 modules may be implemented by a web browser executed by the front-end computer 150.

The user interface software module 151 may be configured to generate, render, and display a user interface. Example user interfaces that may be generated by the user interface software module 151 are shown in FIG. 2-8. The user interface may be displayed to the user using a display device (not shown). For example, the user interface module 151 may be configured to generate and present an interface for interacting with visualization data, such as charts and/or graphs.

The data querying software module 152 may be configured to generate queries to send to the back-end computer 170. The queries may request data to be processed and visualized on the user interface. For example, the data querying module 152 may send queries to the back-end server 170 to receive information on a data model to be visualized as charts and graphs in the user interface.

The interface processing software module 153 may be configured to determine or detect changes to the user interface, generate visualizations (e.g., charts and graphs), and generate recommendations for comparisons, as further described below.

The front-end storage module 154 may be configured to store data to and retrieve data from a memory of the front-end computer 150 (not shown). The memory may be a system memory or a file system of the front-end computer 150, for example. The front-end storage module 154 may handle storage of interface configuration data and models and storage of query responses, for example. The front-end computer 150 and the back-end computer 170 may be configured to communicate with each other over a network (not shown), such as the Internet or an intranet.

The back-end computer includes a data provisioning software module 171 and a back-end storage software module 172. The back-end computer 170 may be a server computer or a system of more than one computer, for example. The back-end computer 170 provides back-end processing for the cloud application provided by the front-end computer 150. The back-end computer 170 may be a server computer or a system of more than one computer, for example. The back-end computer 170 provides back-end processing for the cloud application provided by the front-end computer 150.

The data provisioning module 171 may be configured to receive and process the queries send by the data querying module 152 of the front-end computer 150. For example, the back-end computer may store a dataset formatted from source data (e.g., reports or logs) and a data model may be generated based on the data set. The data provisioning module 171 may provide information of the data model in response to queries from the front-end computer 150. The front-end computer 150 may use the information included in the query responses sent by the data provisioning module 171 to generate charts and/or graphs of the model generated based on the dataset, for example. The data model to be visualized as charts and graphs may include measures and dimensions. A “measure” may refer to a set of category of a numerical values in a model. For example, gross margin, sales price, quantity sold, revenue, and discount may be measures in the model. Values of the same measure can be summed together to get a cumulative value. A “dimension” may refer to a qualitative description of the data in the model. For example, time (e.g., year, quarter, month, etc.), category, location, product, manager, and store may be dimensions in the model.

The features and advantages of the analytics application providing recommendations for comparisons of data over time are further described below.

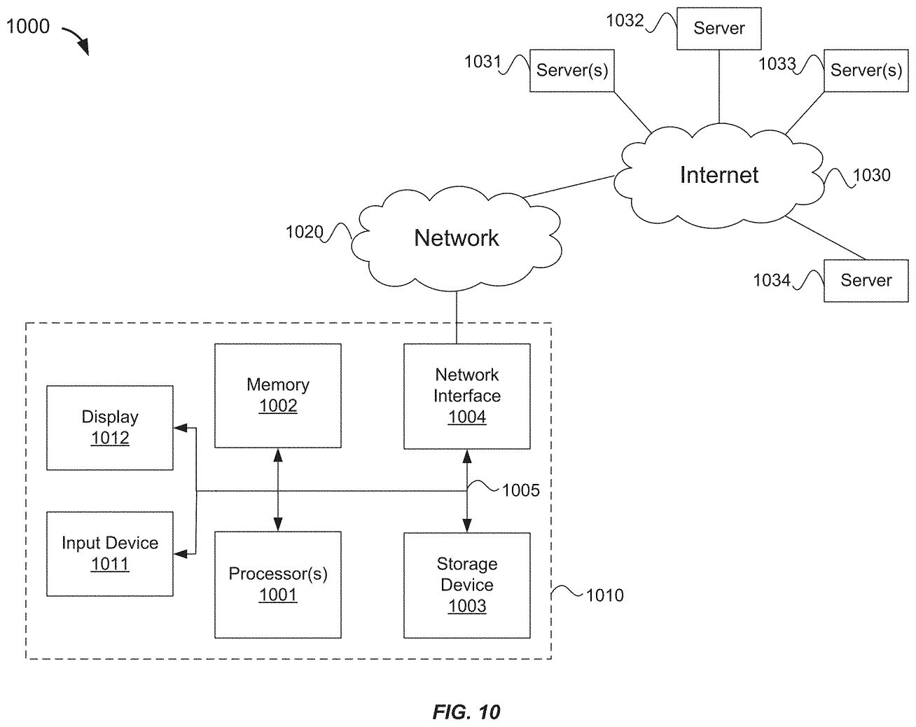

FIG. 2 shows a flowchart 200 of a computer implemented method, according to an embodiment. The computer implemented method may be perform by the back-end computer 170 of FIG. 1, for example. In some embodiments, the computer implemented method may be implemented by the computer system 1010 of FIG. 10.

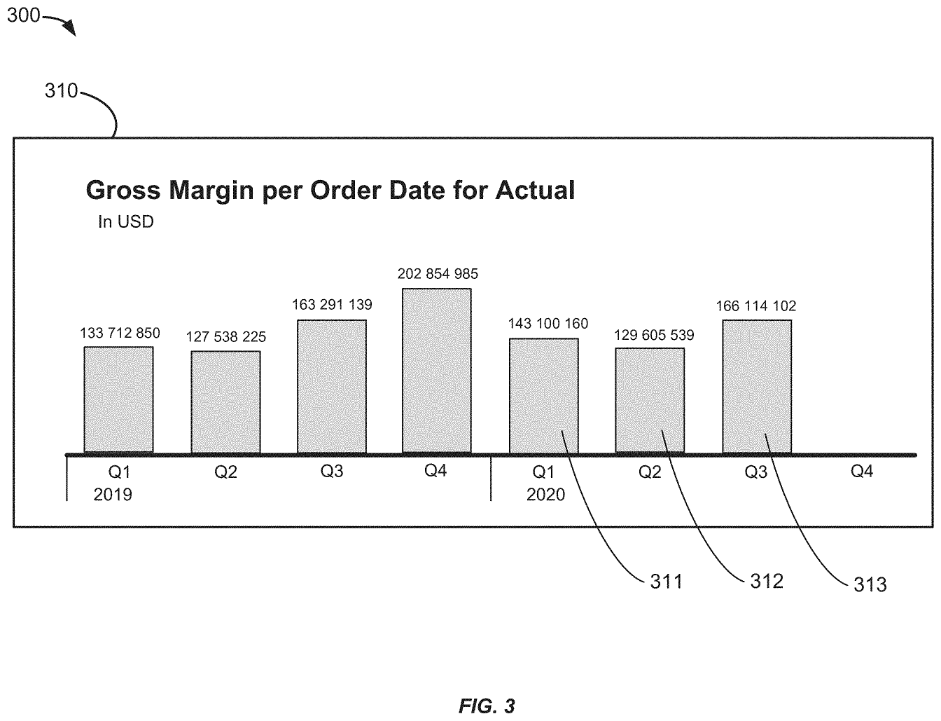

At 201, the method may generate a visualization including a plurality of data points based on data retrieved by querying a server, the visualization for display on a user interface. An exemplary visualization including a plurality of data points based on data retrieved by a server is described below with respect to FIG. 3. The querying of the server may be performed as described above with respect to FIG. 1. For example, a back-end computer may retrieve data from a database server using a query and generate a visualization of the retrieved data for presentation in a user interface of a front-end computer. The plurality of data points may be elements within the user interface. For example, as described below with respect to FIG. 3, data regarding “Gross Margin per Order Data for Actual” may include data points for the first quarter (Q1) of 2019, the second quarter (Q2) of 2019, the quarter (Q3) of 2019, and so on through Q3 and Q4 of 2020. As described below, these data points may be represented as distinct bars of a bar chart. For example, as described below with respect to FIG. 3, the gross margin for Q1 of 2020 for actual was 143,100,160 USD, the gross margin for Q2 of 2020 for actual was 129,605,539 USD, and the gross margin for Q3 of 2020 for actual was 166,114,139102 Additional details of FIG. 3 are described below.

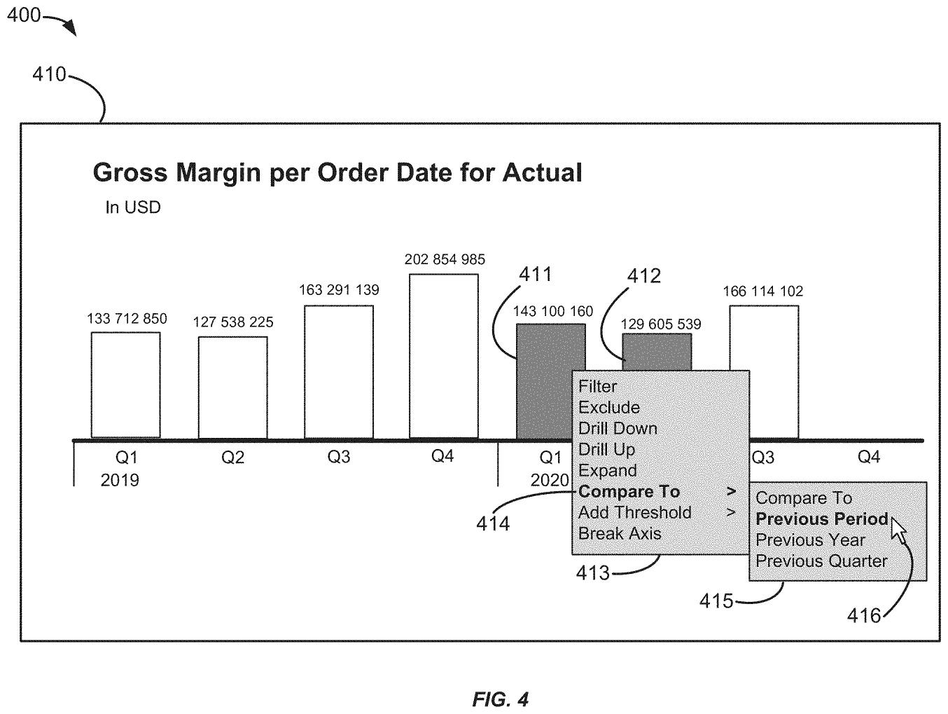

At 202, the method may determine a selection of one or more selected data points of the plurality of data points. The selection may be made using the user interface. An example of a selection of one or more selected data points of the plurality of data points is described below with respect to FIG. 4. For example, as described below, a user may have selected two bars (e.g., data points) in a bar chart: Q1 of 2020 and Q2 of 2020. These bars may have been selected by clicking and dragging a mouse pointer over both bars in the user interface, for example. The bars (e.g., data points) for Q1 of 2020 and Q2 of 2020 are the one or more selected data points in that example.

At 203, the method may determine that a context of the visualization is based on time. For example, time or a time period may be a dimension of the visualization such that it is along an axis, or time may be used to filter the data being shown in the visualization. If a context of the visualization is based on time, then it may be possible to determine comparisons of data over time. Referring to FIG. 4, the visualization shown has a context that is based on a time because the visualization has the quarterly time period along the axis. The “context” refers to the information used to generate the visualization. Since the gross margin per order date of FIG. 4 is aggregated per quarter of the year, then the context is based on time periods in that example. In this example, the gross margin for one quarter may be compared to the gross margin for another quarter.

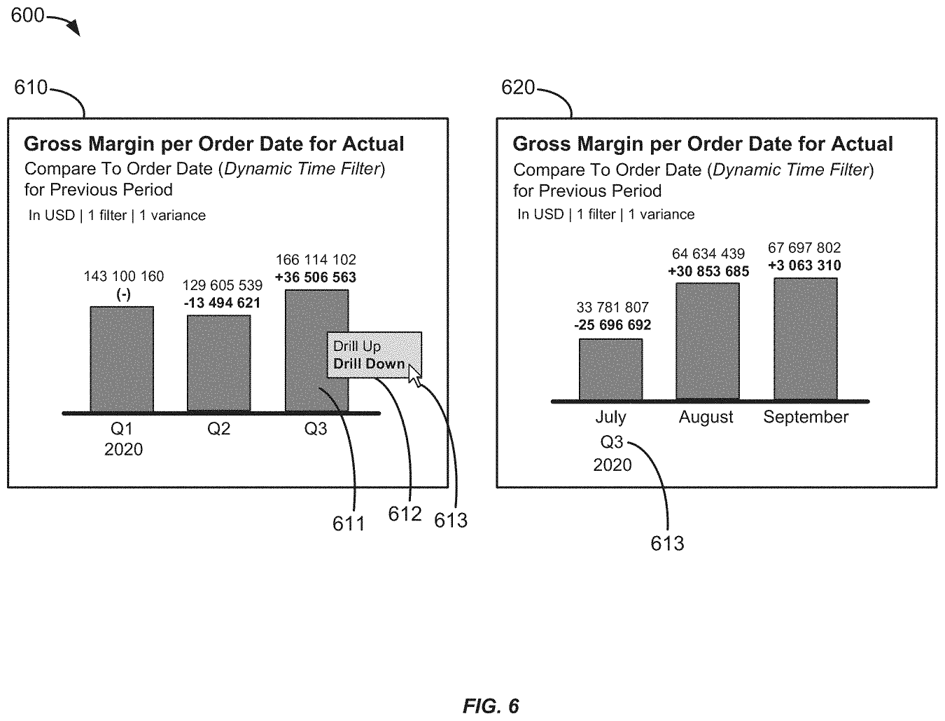

At 204, the method may determine one or more data comparisons by comparing each of the one or more selected data points to a corresponding data point in a previous time period. For example, if the period is quarters of the year, the data points for a particular quarter may be compared to the preceding quarter. An example of the data comparisons is described below with respect to FIG. 6. As shown in FIG. 6, the 129,605,539 USD of gross margin per actual for Q2 of the year 2020 may be compared to the 143,100,160 USD of gross margin per actual for the preceding quarter, Q1 of the year 2020. As shown in FIG. 6, the data comparison indicates a −10,494,621 USD change in gross margin per actual for Q2 compared to Q1.

At 205, the method may generate a second visualization including the one or more selected data points and the one or more data comparisons for presentation in the user interface. An example of a visualization including the one or more data comparisons is described below with respect to As shown in FIG. 6, the data comparison indicates a −10,494,621 USD change in gross margin per actual for Q2 compared to Q1. FIG. 6 also shows a data comparison based on Q3 and its preceding quarter (Q2): +36,506,563 (i.e., the gross margin in Q3 was 36,506,563 USD greater than the gross margin in Q2).

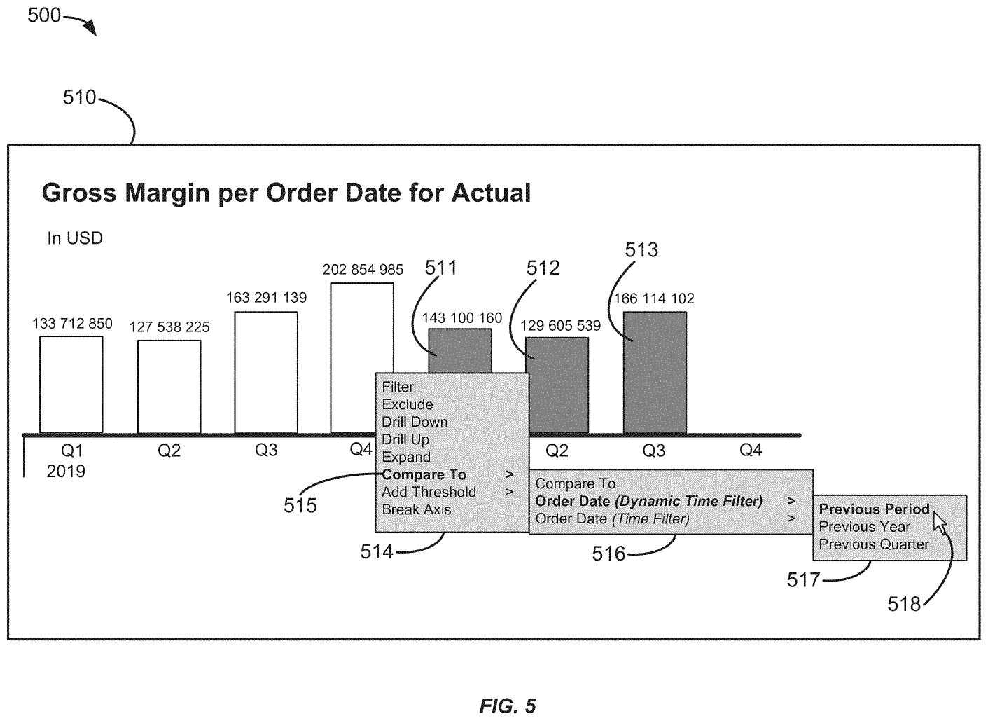

In some embodiments, the method may further determine whether the one or more selected data points includes a current time period. An example of one or more selected data points including a current time period is described below with respect to FIG. 5. As described below, the current date may be within the third quarter (Q3) of 2020. Accordingly, the current time period is Q3 of 2020. As shown in FIG. 5, Q1 of 2020, Q2 of 2020, and Q3 of 2020 are selected. As such, the current time period (Q3) is selected.

In some embodiments, the method may further generate a recommendation, for displaying in the user interface, to generate dynamic comparisons based on the determination of whether the one or more selected data points includes the current time period. An example of such a recommendation is described below with respect to FIG. 5. As shown in FIG. 5, a menu including a recommendation (i.e., the “Compare to” selectable element, the corresponding menu including the “compare to order date (dynamic time filter)” selectable element, and the “compare to order date (time filter)” selectable element). These recommendations may be based on the selected data points and whether or not they include the current time period. For example, as in FIG. 5, if the current date is within Q3 of the year 2020, and Q1, Q2, and Q3 are the selected data points, then the selected data points include the current time period (i.e., Q3). If the selected data points includes the current time period than a recommendation to create a dynamic time filter may be generated and displayed in the user interface. Techniques for determining data comparisons and generating visualizations is further described below.

FIG. 3 shows a diagram 300 of an exemplary visualization 310 of data presented in a user interface, according to an embodiment. As described above, FIG. 3 shows an example of a visualization including a plurality of data points based on data retrieved by querying a server. For example, the plurality of data points include the data for each Quarter (e.g., the bars representing Q1 of 2019 through Q3 of 2020). As shown in FIG. 3, the plurality of data points include a first data point 311 for Q1 of 2020 (e.g., the bar representing 143,100,160 USD of gross margin), a second data point 312 for Q2 of 2020 (e.g., the bar representing 129,605,539 USD of gross margin), and a third data point 313 for Q3 of 2020 (e.g., the bar representing 166,114,102 USD of gross margin).

Referring back to FIG. 3 as a whole, this exemplary visualization 310 shows gross margin per order data for actual. As shown in FIG. 3, the order data is grouped by quarter. As discussed above, it would be advantageous for the user to compare the data for these quarters to the data in previous quarters in order to draw conclusions from that information. Based on the data for this visualization, the software can determine that time is in the context of the visualization based on time being in the axis. Here, the quarters of the years 2019 and 2020 are along the x-axis of the bar graph. Therefore, it may be possible to compare the data shown to previous quarters. For example, Q4 of 2020 may be compared to Q3 of 2020 or it may be compared to Q4 of 2019, as further described below.

FIG. 4 shows a diagram 400 of an exemplary visualization 410 of data and a selection of data points, according to an embodiment. The visualization 410 may be configured similar to the visualization 310 of FIG. 3 described above but where a user has further selected Q1 and Q2 of 2020 and initiated a menu 413.

In this example, the current time (e.g., the actual date that the user is using the software and viewing this visualization) is within Q3 of the year 2020. In FIG. 4, a user has selected two data points: the bar 411 for the first quarter (Q1) of 2020 and the bar 412 for the second quarter (Q2) of 2020. In response to this selection, a menu 413 may be presented. In some embodiments, the menu 413 may be presented based on the user clicking or hovering over the selected elements in the user interface. The menu 413 includes a recommendation to create a comparison (i.e., the “compare to” selectable element 414 in the menu). If the user selects (e.g., clicks or hovers over) this recommendation 414, a further menu 415 may be presented with several recommendations including a recommendation 416 to compare to the previous period, a recommendation to compare to the previous year, and another recommendation to compare to a previous quarter.

In order to make the recommendations, the software determines that time is in the visualization (i.e., it is along the x-axis) and that the current time period is not selected (i.e., Q3 is not selected). The software generates recommended time-based data comparisons based on the user's selection of the two data points. In this example, the recommended comparisons are comparisons to the previous period, the previous year, and the previous quarter. The software may be configured such that the “previous period” comparison may change along with the time hierarchy level (e.g., year, quarter, month, etc.) of the visualization. For example, if the user sets the visualization to display data by year, then the previous period comparison will be year to year. If the user sets the visualization to display by month, then the previous period comparison will be month to month.

FIG. 5 shows a diagram 500 of an exemplary visualization 510 of data and a selection of data points including a current time period, according to an embodiment. The visualization 510 of FIG. 5 may be configured similar to the visualization 410 of FIG. 4 except that the user has also selected the current quarter, Q3 of 2020. The visualization 510 includes bar 511 for Q1 of 2020, bar 512 for Q2 of 2020, and bar 513 for Q3 of 2020, each of which are selected.

In this example, the current time (e.g., the actual date that the user is using the software and viewing this visualization) is within Q3 of the year 2020. In FIG. 5, a user has selected three data points: the bar for the first quarter (Q1) of 2020, the bar for the second quarter (Q2) of 2020, and the bar for the third quarter (Q3), which is the current quarter. In response to this selection, the software determines that time is in the visualization (i.e., it is along the x-axis) and that the current time period is selected (i.e., Q3 is not selected). Based on these two determinations, the software makes a recommendations to enable the user to create dynamic comparisons in addition to the previously described comparisons. Such “dynamic comparisons” may update based on the actual date that the user accesses the software, such that when it becomes the fourth quarter the comparisons will reflect the fourth quarter instead of the third quarter. Dynamic time-based comparisons are advantageous because the user may save (e.g., bookmark) the comparisons such that when they review the visualization again next month, they do not have to re-create the comparisons based on the current time period.

As shown in FIG. 5, a menu 513 may be presented when a user selects a data point (e.g., a bar in a bar graph). In some embodiments, the menu 513 may be presented based on the user clicking or hovering over the selected elements in the user interface. The menu 513 includes a recommendation 515 to create a comparison (i.e., the “compare to” selectable element 514 in the menu). If the user selects (e.g., clicks or hovers over) this recommendation 515, a further menu 516 may be presented with several recommendations including a recommendation to compare using a “dynamic time filter” since the selection includes the current date. If this recommendation is selected, further recommendations may be presented in another menu 517, including a recommendation 518 to compare to the previous period, a recommendation to compare to the previous year, and another recommendation to compare to a previous quarter. As further described below with respect to FIG. 6, the user in this example selects the recommendation 518 to compare the to the “previous period.”

Another advantage of the techniques described herein is that a viewer of the visualization (e.g., the visualizations shown in FIGS. 4 and 5) may be provided with recommendations to generate companions and they may create such comparisons and include them in their user interface along with the visualization. This may be done without the user having designer-level permissions to create, edit, or modify the underlying visualization itself. Thus, even if the designer fails to include this important information, the viewer is able to add the comparisons to the visualization based on the recommendations without any designer-level training or understanding of the back-end server.

FIG. 6 shows a diagram 600 of an exemplary visualization 610 of data with time-based comparisons dynamically adjusting based on a time period level, according to an embodiment. As discussed above, the analytics software may determine whether time-based comparisons may be generated for a particular visualization and it may provide recommendations to the user to generate such comparisons. FIG. 6 shows time-based comparisons of data above the bar graphs. For instance, the gross margin per order data for actual is shown as the top number above the bar and the comparison of the gross margin to the gross margin in a previous period (e.g., previous month, or same month last year, etc.) is shown below that. The user may also be provided with an option menu 612 to “drill up” or “drill down” to change the time period from quarter to months, or from quarters to years, for example. In this example, the user has selected the bar 611 and then selects 613 “drill down” in the menu 612. The visualization 620 is generated by the software in response to the user drilling down. The visualization 610 includes data for the month of Q3: July, August, and September. As shown in FIG. 6, the visualization 620 includes comparisons of data over time (e.g., the gross margin per order data for actual is compared to the previous month, where months are the time period used in the visualization 620).

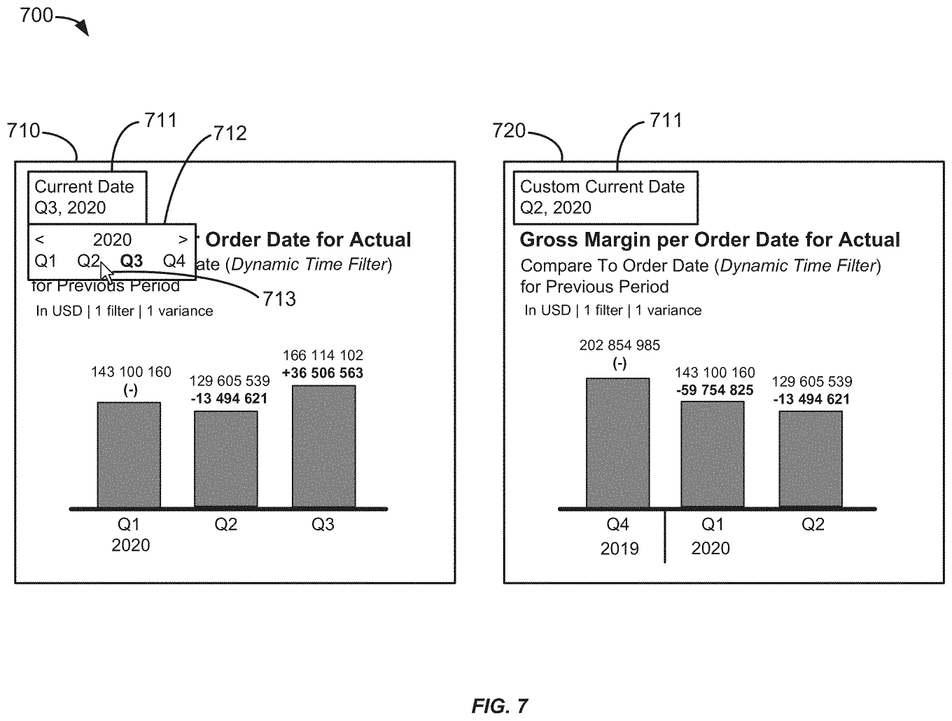

FIG. 7 shows a diagram 600 of an exemplary visualization 710 of data with time-based comparisons and an interface control option 711 to select 713 a custom current date 712, according to an embodiment. In this example, the current time (e.g., the actual date that the user is using the software and viewing this visualization) is within Q3 of the year 2020. However, the analytics software provides a user interface control selection, shown in the upper-left, that enables the viewer to select a custom current time period. In this example, the viewer has selected the second quarter as their custom current time period. Accordingly, the data in the visualization has been updated to reflect that the current time period is Q2 (instead of the actual time period of Q3). The resulting visualization 720 shows different data based on the custom current date selected (i.e., Q2 was selected as the custom current date). Thus, the user may view the gross margin per order date for actual as if the current date were within Q2 (instead of Q3).

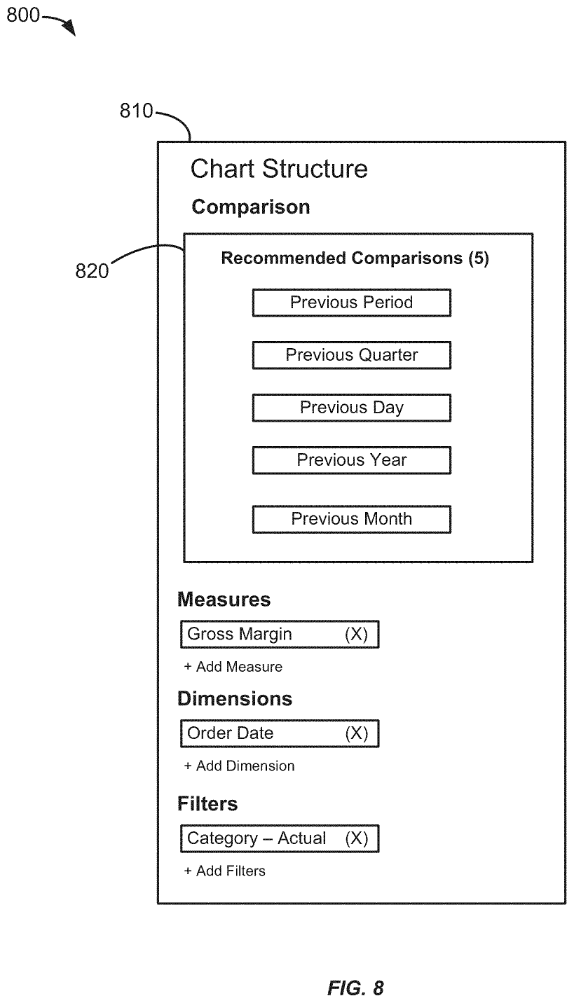

FIG. 8 shows a diagram 800 of recommendations 820 for comparisons to generate for a visualization of data, according to an embodiment. The recommended comparisons 820 may be shown in a designer-level menu 810 for creating visualizations. As shown in FIG. 8, several different time periods may be recommended for comparison. For example, the designer may set the visualization to show comparisons based on the previous period, the previous year, the previous quarter, the previous month, or the previous day. The designer may also configure which measures and dimensions are in the chart and whether any filters are applied.

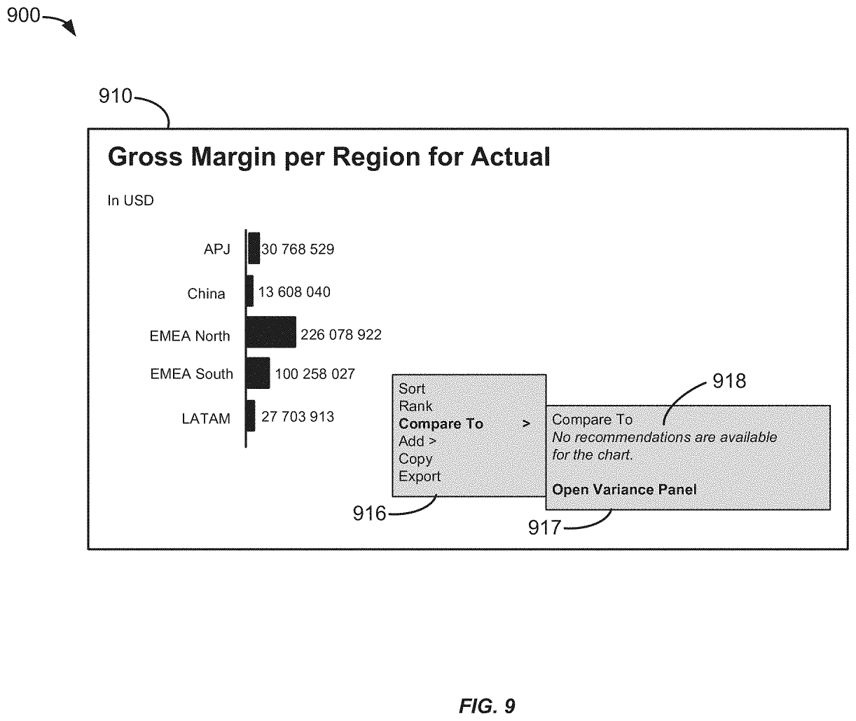

FIG. 9 shows a diagram 900 of a notification 918 regarding comparisons of data, according to an embodiment. As mentioned above, the analytics software determine whether time is in the context of the visualization in order to determine whether to provide recommendations for time-based comparisons. If time is not in the context, the analytics software may generate a notification 918 indicating that recommendations are not available for the current visualization 910. The notification 918 may be an indication to the user that there are no recommendations available for this chart.

For example, as shown in FIG. 6, the user may open a configuration menu 916 for a visualization 910 showing Gross Margin per Region for Actual. If the user selects the “compare to” element in the menu 916, another configuration menu 917 is presented with a notification 918. In this example, the notification states “No recommendations are available for the chart.” The enables the user to recognize that they can add time into the context of the visualization in order to create such comparisons. FIG. 9 shows Gross Margin per Region for Actual without having time in an axis or using time as a filter. Thus, time is not in the context of the visualization 910. However, the user may filter the visualization based on a time period (e.g., the past year, or past quarter) such that time is in the context of the visualization 910. If the user does this, then recommendations for comparisons may be shown in the menu instead of the notification 918.

FIG. 10 shows a diagram of hardware of a special purpose computing machine for implementing the systems and methods described herein for generating recommendations for comparisons of data over time. The following hardware description is merely one example. It is to be understood that a variety of computers topologies may be used to implement the above described techniques.

An example computer system 1010 is illustrated in FIG. 10. Computer system 1010 includes a bus 1005 or other communication mechanism for communicating information, and one or more processor(s) 1001 coupled with bus 1005 for processing information. Computer system 1010 also includes a memory 1002 coupled to bus 1005 for storing information and instructions to be executed by processor 1001, including information and instructions for performing some of the techniques described above, for example. This memory may also be used for storing programs executed by processor(s) 1001. Possible implementations of this memory may be, but are not limited to, random access memory (RAM), read only memory (ROM), or both. A storage device 1003 is also provided for storing information and instructions. Common forms of storage devices include, for example, a hard drive, a magnetic disk, an optical disk, a CD-ROM, a DVD, a flash or other non-volatile memory, a USB memory card, or any other medium from which a computer can read. Storage device 1003 may include source code, binary code, or software files for performing the techniques above, for example. Storage device and memory are both examples of non-transitory computer readable storage mediums. For example, the storage device 1003 may store computer program code including instructions for implementing the method described above with respect to FIG. 2.

Computer system 1010 may be coupled using bus 1005 to a display 1012 for displaying information to a computer user. An input device 1011 such as a keyboard, touchscreen, and/or mouse is coupled to bus 1005 for communicating information and command selections from the user to processor 1001. The combination of these components allows the user to communicate with the system. In some systems, bus 1005 represents multiple specialized buses, for example.

Computer system also includes a network interface 1004 coupled with bus 1005. Network interface 1004 may provide two-way data communication between computer system 1010 and a network 1020. The network interface 1004 may be a wireless or wired connection, for example. Computer system 1010 can send and receive information through the network interface 1004 across a local area network, an Intranet, a cellular network, or the Internet, for example. In the Internet example, a browser, for example, may access data and features on backend systems that may reside on multiple different hardware servers 1031-1034 across the network. The servers 1031-1034 may be part of a cloud computing environment, for example.

The computer system 1010 may implement a computer implemented method for generating comparisons of data. The computer-implemented method may include generating a visualization including a plurality of data points based on data retrieved by querying a server, the visualization for display on a user interface. The computer-implemented method may include determining a selection of one or more selected data points of the plurality of data points, the selection made using the user interface. The computer-implemented method may include determining that a context of the visualization is based on a time period. The computer-implemented method may include determining one or more data comparisons by comparing each of the one or more selected data points to a corresponding data point in a previous time period. The computer-implemented method may include generating a second visualization including the one or more selected data points and the one or more data comparisons for presentation in the user interface.

In some embodiments, the determination that the context of the visualization is based on time may include determining that a time period is used along an axis of the visualization or determining that the visualization is filtered based on the time period.

In some embodiments, the computer-implemented method may include generating a recommendation, for displaying in the user interface, to generate comparisons based on the determination that the context of the visualization is based on time.

In some embodiments, the computer-implemented method may include determining whether the one or more selected data points includes a current time period. The computer-implemented method may also include generating a recommendation, for displaying in the user interface, to generate dynamic comparisons based on the determination of whether the one or more selected data points includes the current time period.

In some embodiments, the data comparisons are dynamically determined based on the current time period.

In some embodiments, the current time period is one of the current year, the current quarter, or the current month.

In some embodiments, the visualization is a bar chart or a line chart.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations, and equivalents may be employed without departing from the scope of the present disclosure as defined by the claims.

What is claimed is:

1. A computer system, comprising:
one or more processors; and
one or more machine-readable medium coupled to the one or more processors and storing computer program code comprising sets instructions executable by the one or more processors to:
generate a visualization including a plurality of data points based on data retrieved by querying a server, the visualization for display on a user interface;
determine a selection of one or more selected data points of the plurality of data points, the selection made using the user interface;
determine that a context of the visualization is based on time;
determine one or more data comparisons by comparing each of the one or more selected data points to a corresponding data point in a previous time period; and
generate a second visualization including the one or more selected data points and the one or more data comparisons for presentation in the user interface.

2. The computer system of claim 1, wherein the determination that the context of the visualization is based on time includes determining that a time period is used along an axis of the visualization or determining that the visualization is filtered based on the time period.

3. The computer system of claim 1, wherein the computer program code further comprises sets of instructions executable by the one or more processors to:
generate a recommendation, for displaying in the user interface, to generate comparisons based on the determination that the context of the visualization is based on time.

4. The computer-implemented method of claim 1, wherein the computer program code further comprises sets of instructions executable by the one or more processors to:
determine whether the one or more selected data points includes a current time period; and
generate a recommendation, for displaying in the user interface, to generate dynamic comparisons based on the determination of whether the one or more selected data points includes the current time period.

5. The computer-implemented method of claim 4, wherein the data comparisons are dynamically determined based on the current time period.

6. The computer-implemented method of claim 4, wherein the current time period is one of the current year, the current quarter, or the current month.

7. The computer-implemented method of claim 1, wherein the computer program code further comprises sets of instructions executable by the one or more processors to:
obtain an indication of a custom current time period from the user interface; and
generate a third visualization including data comparisons based on the custom current time period.

8. One or more non-transitory computer-readable medium storing computer program code comprising sets of instructions to:
generate a visualization including a plurality of data points based on data retrieved by querying a server, the visualization for display on a user interface;
determine a selection of one or more selected data points of the plurality of data points, the selection made using the user interface;
determine that a context of the visualization is based on time;
determine one or more data comparisons by comparing each of the one or more selected data points to a corresponding data point in a previous time period; and
generate a second visualization including the one or more selected data points and the one or more data comparisons for presentation in the user interface.

9. The non-transitory computer-readable medium of claim 8, wherein the determination that the context of the visualization is based on time includes determining that a time period is used along an axis of the visualization or determining that the visualization is filtered based on the time period.

10. The non-transitory computer-readable medium of claim 8, wherein the computer program code further comprises sets of instructions to:
generate a recommendation, for displaying in the user interface, to generate comparisons based on the determination that the context of the visualization is based on time.

11. The non-transitory computer-readable medium of claim 8, wherein the computer program code further comprises sets of instructions to:
determine whether the one or more selected data points includes a current time period; and
generate a recommendation, for displaying in the user interface, to generate dynamic comparisons based on the determination of whether the one or more selected data points includes the current time period.

12. The non-transitory computer-readable medium of claim 11, wherein the data comparisons are dynamically determined based on the current time period.

13. The non-transitory computer-readable medium of claim 11, wherein the current time period is one of the current year, the current quarter, or the current month.

14. The non-transitory computer-readable medium of claim 8, wherein the computer program code further comprises sets of instructions to:
obtain an indication of a custom current time period from the user interface; and
generate a third visualization including data comparisons based on the custom current time period.

15. A computer-implemented method, comprising:
generating a visualization including a plurality of data points based on data retrieved by querying a server, the visualization for display on a user interface;
determining a selection of one or more selected data points of the plurality of data points, the selection made using the user interface;
determining that a context of the visualization is based on time;
determining one or more data comparisons by comparing each of the one or more selected data points to a corresponding data point in a previous time period; and
generating a second visualization including the one or more selected data points and the one or more data comparisons for presentation in the user interface.

16. The computer-implemented method of claim 15, wherein the determination that the context of the visualization is based on time includes determining that a time period is used along an axis of the visualization or determining that the visualization is filtered based on the time period.

17. The computer-implemented method of claim 15, further comprising:
generating a recommendation, for displaying in the user interface, to generate comparisons based on the determination that the context of the visualization is based on time.

18. The computer-implemented method of claim 15, further comprising:
determining whether the one or more selected data points includes a current time period; and
generating a recommendation, for displaying in the user interface, to generate dynamic comparisons based on the determination of whether the one or more selected data points includes the current time period.

19. The computer-implemented method of claim 18, wherein the data comparisons are dynamically determined based on the current time period.

20. The computer-implemented method of claim 15, further comprising:
obtaining an indication of a custom current time period from the user interface; and
generating a third visualization including data comparisons based on the custom current time period.
